(19) United States
(12) Patent Application Publication
(10) Pub. No.: US 2008/0254354 A1
(43) Pub. Date: Oct. 16, 2008

(54) CONNECTION SYSTEM FOR AN ELECTROCHEMICAL CELL

(75) Inventor: Grant R. Adams, Enola, PA (US)

Correspondence Address: SUGHRUE MION, PLLC, 2100 PENNSYLVANIA AVENUE, N.W., SUITE 800, WASHINGTON, DC, 20037, US

(73) Assignee: SAFT, Bagnolet (FR)

(21) Appl. No.: 11/734,021

(22) Filed: Apr. 11, 2007

(51) Int. Cl. H01M 2/02

(52) U.S. Cl. 429/125; 29/623.2; 29/731

(57) ABSTRACT

An electrochemical cell includes a can and a jelly roll disposed in the can. The jelly roll includes a positive electrode and a negative electrode, wherein positive winding foils protrude from a positive end of the jelly roll and negative winding foils protrude from a negative end of the jelly roll. The positive winding foils are folded in a same direction to overlap each other in a first pattern of recesses and the negative winding foils are folded in a same direction to overlap each other in a second pattern of recesses. A positive disk includes a plurality of leg forms welded into the first pattern of recesses formed in the positive winding foils. A negative disk includes a plurality of leg forms welded into the second pattern of recesses formed in the winding foils. At least one of the positive disk and the negative disk is electrically insulated from the can.

### BACKGROUND OF THE INVENTION

Electrochemical cells are commonly known as batteries. A particular kind of electrochemical cell includes an alternating sequence of spirally wound positive and negative electrodes constituting the electrochemical bundle. This arrangement is commonly known as a “jelly roll.”

FIG. 1 shows a cross-section of one end of a jelly roll electrochemical cell disclosed in U.S. Pat. No. 5,849,431, which is incorporated herein by reference in its entirety. In FIG. 1, a spirally wound electrode assembly 35 is made by wrapping a positive electrode, a negative electrode, and a separator around a core 31. Extending from the winding foil of the positive electrode are rectangular leads 11, also referred to as “tabs.” The leads 11 are attached to a terminal 20, typically by welding. A similar terminal exists on the other end of the electrode assembly to form the negative terminal.

The tabs are typically welded to the electrodes. During this welding, weld spatter may fall into the windings of the jelly roll, which can cause electrical shorts. Prior art tabs are typically thin, metal foils. During vibration, one or more of the tabs may break, partially severing the electrical path from the electrode assembly and the terminal. The additional step of attaching the tabs to the electrode assembly also increases assembly time of the electrochemical cell.

U.S. Publication No. 2005/0008933 discloses a tabless jelly roll type of electrochemical cell. Instead of using tabs to connect the electrodes to the respective terminals, a tabless jelly roll attaches a current collecting plate directly to the electrodes. To provide a surface for welding, part of the metallic winding foils of each electrode extend past the active portion of the electrochemical bundle. The ends of the winding foils are folded into a plane by pressing down on the winding foils for partially crush them. The current collecting plate is then welded directly to the flattened portion of the winding foils.

Pressing downward in an axial direction on the winding foils can cause them to bend in varying directions as the winding foils buckle under the pressure. Such a result is shown in FIG. 2. Because of the random folding of the winding foils, gaps may exist between neighboring winding foils. When the current collecting plate is welded, areas over such gaps become over-heated, potentially resulting in the welder burning a hole through the current collecting plate. This can result in irreparable damage to the electrochemical bundle, wasting the significant expense that has already occurred by that point in the manufacture of the battery.

### SUMMARY OF THE INVENTION

In one aspect, the present invention relates to an electrochemical cell including a can and a jelly roll disposed in the can. The jelly roll includes a positive electrode and a negative electrode, wherein positive winding foils protrude from a positive end of the jelly roll and negative winding foils protrude from a negative end of the jelly roll. The positive winding foils are folded in a same direction to overlap each other in a first pattern of recesses and the negative winding foils are folded in a same direction to overlap each other in a second pattern of recesses. A positive disk includes a plurality of leg forms welded into the first pattern of recesses formed in the positive winding foils. A negative disk includes a plurality of leg forms welded into the second pattern of recesses formed in the winding foils. At least one of the positive disk and the negative disk is electrically insulated from the can.

In another aspect, the present invention relates to a method of manufacturing an electrochemical cell that includes a tabless jelly roll. The method includes applying a radial force across positive winding foils on a positive end of the tabless jelly roll such that the positive winding foils are folded in a radial direction to overlap each other in a first pattern of recesses. A radial force is applied across negative winding foils on a negative end of the tabless jelly roll such that the negative winding foils are folded in a radial direction to overlap each other in a second pattern of recesses. A positive disk and a negative disk are provided, wherein the positive disk includes a plurality of leg forms corresponding to the first pattern of recesses formed in the positive winding foils and the negative disk includes a plurality of leg forms corresponding to the second pattern of recesses formed in the negative winding foils. The plurality of leg forms of the positive disk and the negative disk are welded to the first pattern of recesses formed in the positive winding foils and the second pattern of recesses formed in the negative winding foils, respectively. The tabless jelly roll is disposed into a can. At least one of the positive disk and the negative disk is electrically insulated from the can.

Other exemplary embodiments and advantages of the invention will be apparent from the following description and the appended claims.

### BRIEF DESCRIPTION OF THE DRAWINGS

FIG. 1 is a cross-section of a prior art electrochemical cell.

FIG. 2 is a cross-section of winding foils that have been axially pressed.

FIG. 3 is a cross-section of an electrochemical cell in accordance with an embodiment of the present invention.

FIG. 4 is an exploded view of a positive terminal of an electrochemical cell assembly in accordance with an embodiment of the present invention.

FIG. 5 is a cross-section of the positive terminal of the electrochemical cell assembly shown in FIG. 4.

FIG. 6 is a cross-section of a negative terminal of an electrochemical assembly in accordance with an embodiment of the present invention.

FIGS. 7A-7C show a forming tool in accordance with an embodiment of the present invention.

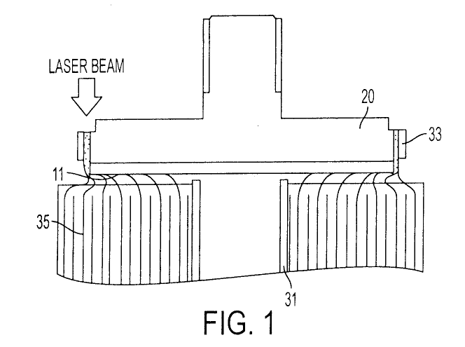

### DETAILED DESCRIPTION OF EXEMPLARY EMBODIMENTS OF THE INVENTION

Embodiments of the present invention relate generally to electrochemical cells having a tabless jelly roll for an electrode assembly.

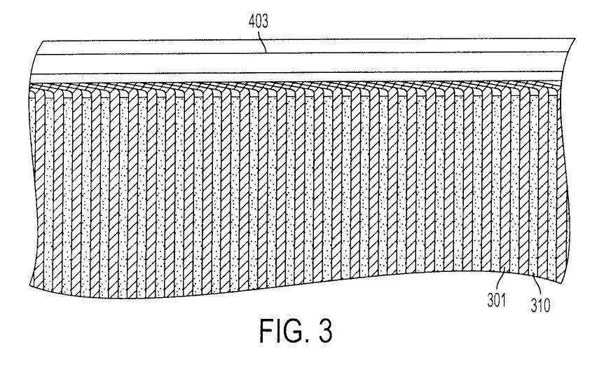

In FIG. 3, a partial cross-section of an electrochemical cell in accordance with an embodiment of the present invention is shown. The electrode assembly 310 is similar to the prior art tabless jelly roll described above. Winding foils 301 protrude from the electrode assembly 310. For the positive end of the electrode assembly, the winding foils extend from the positive electrode, and, conversely, extend from the negative electrode for the negative end of the electrode assembly. The protruding portions of the winding foils 301 are folded over in the same direction, radially outward, so as to overlap according to a predetermined pattern, as shown in FIG. 3. A radial force (i.e. transverse to the axis of the jelly roll) may be applied to the winding foils 301 to fold them over radially inward or outward.

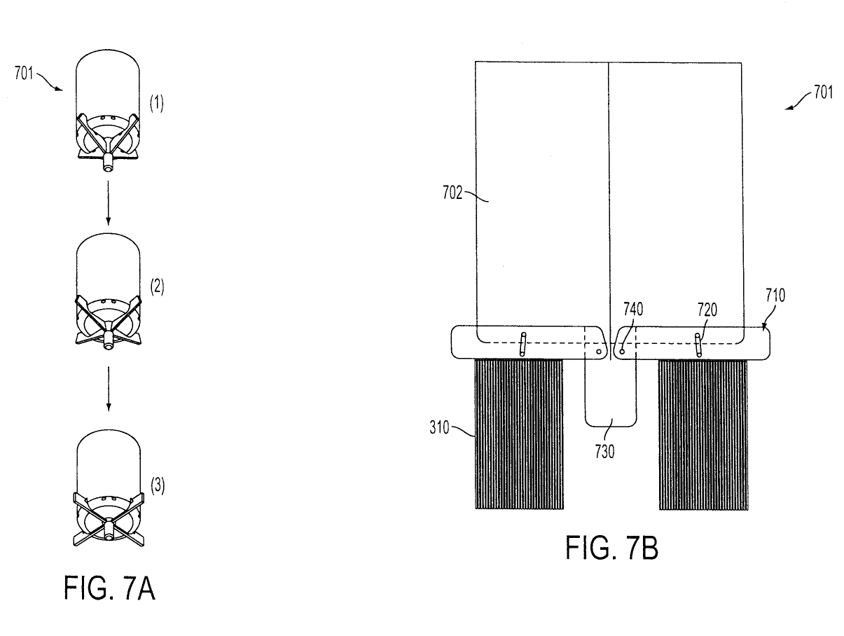

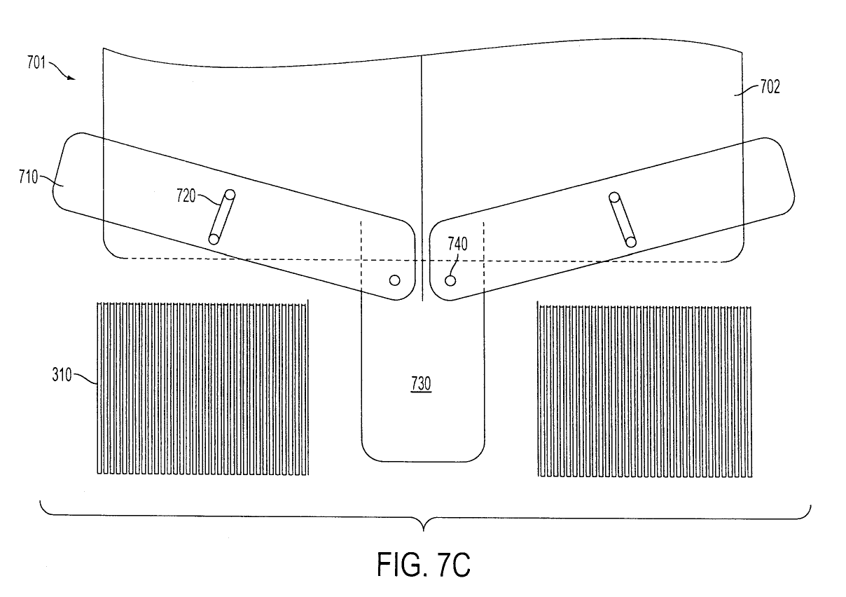

In FIGS. 7A-7C, a forming tool 701 for forming a predetermined pattern of recesses in a jelly roll 310 in accordance with an embodiment of the present invention is shown. The forming tool 701 includes a cylindrical body 702 with a center spindle 730, to which four forming leaves 710 are attached by pins 740 at one end. Towards the middle of the forming leaves 710, the forming leaves are pinned to the body 702 with a slot 720, which allows for the forming leaves 710 to pivot at an angle relative to the spindle 730. The spindle 730 is able to movably extend from the body 702 along an axis. The spindle 730 may be spring-loaded such that the default position of the spindle 730 is extended, which causes the forming leaves 710 to fold at an angle.

FIG. 7A shows the progression of the extension of the spindle 730 relative to the angle of the forming leaves 710. As the forming leaves 710 contact the winding foils of the jelly roll 310, the spindle 730 is pushed inward and the forming leaves 710 fold until they are about perpendicular with the axis of the body 702. FIG. 7C shows a more detailed view of the forming tool 701 before the forming leaves 710 contact the jelly roll 310. FIG. 7B shows the forming leaves 710 after being fully pressed into the jelly roll 310 such that they are substantially perpendicular to the axis of the body 702. As the forming leaves 710 pivot, the winding foils of the jelly roll 310 are folded radially outward beginning from the inner most to the outer most winding foils. As a result, each winding foil folds over on top of the next in an orderly fashion. The pattern, shape, depth, and width of the recesses formed in the jelly roll 310 are determined by the pattern of forming leaves 710. In this particular embodiment, there are four forming leaves 710, and thus, four recesses are formed at about the same time in the jelly roll. Those having ordinary skill in the art will appreciate that there may be more or less forming leaves without departing from the scope of the present invention. Further, the forming tool may be applied more than once to the same end of the jelly roll. For example, after forming the first four recesses at about 90 degrees apart, the forming tool and jelly roll could be rotated 45 degrees relative to each other. Then the forming tool could be pressed again into the jelly roll to form a total of 8 recesses spaced about 45 degrees apart.

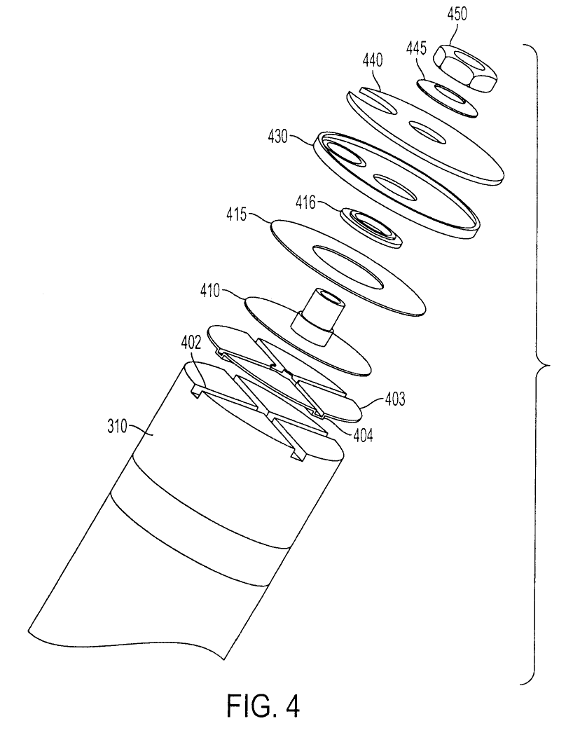

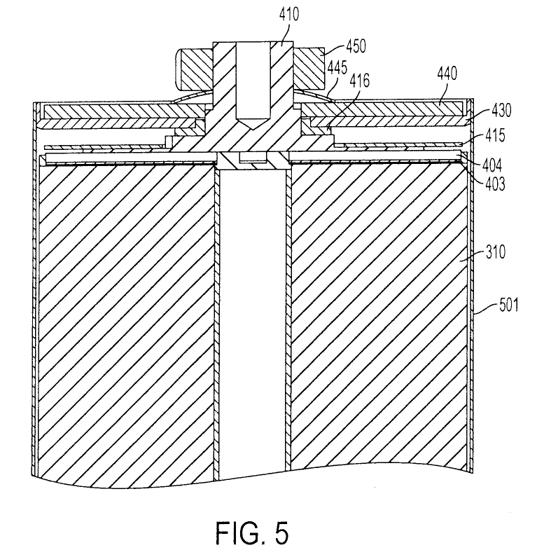

Turning to FIGS. 4 and 5, the electrochemical cell assembly in accordance with an embodiment of the present invention is shown. In FIGS. 4 and 5, the electrode assembly 310 is shown as a solid cylinder for simplicity, and is hereinafter referred to as the “jelly roll.” The folding of the winding foils is performed in a pattern to form a plurality of recesses 402 in the end of the jelly roll 310, which is the positive end in FIGS. 4 and 5. In this particular embodiment, there are four recesses 402; however, those having ordinary skill in the art will appreciate that there may be as few as two recesses 402 and that the upper limit of the quantity of recesses 402 will vary depending on the electrical current requirements and the size of the jelly roll 310. In one embodiment, each recess 402 is about ⅛ inch (3.2 mm) deep; however the invention is not limited in this regard.

After the winding foils 301 are folded over into a pattern of recesses, a disk 403 is provided as a current collector. The disk 403 includes a plurality of legs 404 that correspond to the pattern of recesses 402 in the jelly roll 310. The plurality of legs 404 may have a width and depth about the same as the recesses 402 in order for the disk 403 to fit closely with the end of the jelly roll 310. The bottoms of the plurality of legs 404 are placed in contact with the recesses 402. A welding operation may then be performed along each leg 404 to attach the disk 403 to the jelly roll 310 via the recesses 402. Because the winding foils in the recesses 402 are folded over onto each other, solid, planar surfaces are provided for the welding operation, which allows for a continuous weld to be formed across the jelly roll 310. In one embodiment, laser welding is used for the welding operation.

FIG. 5 shows the assembled positive end of the electrochemical assembly shown in FIG. 4. Before or after the disk 403 is welded to the jelly roll 310, a terminal 410 is attached to the disk 403. In one embodiment, the terminal 410 is welded onto the disk 403 before welding to the jelly roll 310. In another embodiment, the disk 403 and the terminal may be a single piece. The terminal 410 may include a threaded portion to allow a hex nut 450 to be threadably attached to the terminal 410. A seal 416 may be disposed around the terminal 410 to seal the inside of the electrochemical assembly and the atmosphere.

The jelly roll 310 is disposed in a can 501. After attachment of the disk 403 and terminal 410, a cover 430 is placed over the end of the can 501 with the seal 416 between the terminal 410 and the cover 430. On the outside of the cover 430, an insulating washer 440 may be provided to electrically insulate the positive electrode of the jelly roll from the can 501 and the cover 430. To complete the assembly of the positive end of the electrochemical cell, a Bellville or other spring washer 445 may be provided between the hex nut 450 and the insulating washer 440. In one embodiment, the negative end of the electrochemical cell is assembled in a similar manner to the positive end, such that the negative electrode is also electrically insulated. In such an embodiment, the can 501 is neutral and may be in the form of a simple cylinder, rather than having a bottom provided for the negative end. The positive terminal may be made of aluminum. The negative terminal may be, for example, nickel plated copper.

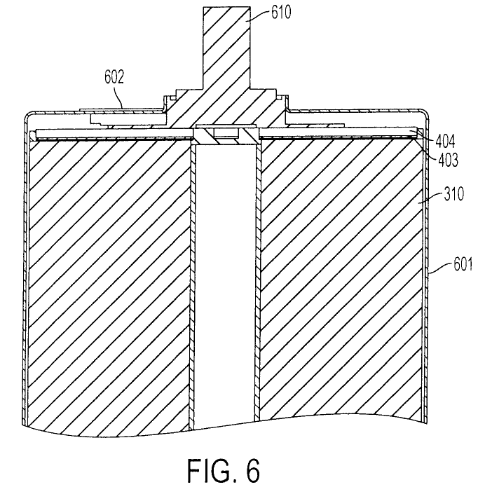

In FIG. 6, a negative end of an electrochemical cell in accordance with an embodiment of the present invention is shown. The disk 403 may be attached to the jelly roll 310 and the terminal 610 in the same manner as that of the positive end of the electrochemical cell. In this embodiment, the can 601 is deep-drawn to have a bottom portion 602. The negative terminal 610 is in contact with the bottom portion of the can 602, thereby causing the can 601 to be negatively charged.

Electrochemical cells in accordance with embodiments of the present invention may have one or more of the following advantages.

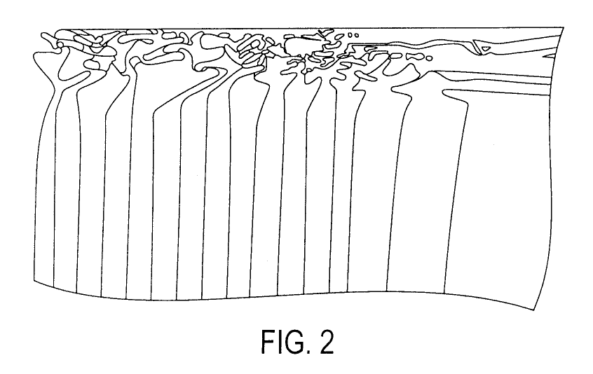

The folded over layer of winding foils in the recesses of the jelly roll provide a penetration barrier during the welding of the disk to the jelly roll. The air gaps associated with axial pressure on the winding foils (see FIG. 2) are avoided by folding the winding foils to overlap each other.

A disk with leg forms corresponding to the pattern of recesses in the jelly roll enhances the rigidity of the jelly roll. As a result, the electrochemical cell is made more resistant to shock and vibration. Additionally, assembly is simplified by avoiding the need to weld tabs to the jelly roll.

The welding of the leg forms to the pattern of recesses in the jelly roll provides an even distribution for thermal and electrical transfers between the jelly roll and the disk. Depending on the size of the electrochemical cell and the electrical transfer requirements, more leg forms may be provided in the disk to correspond to a greater number of recesses in the jelly roll.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An electrochemical cell, comprising:
a can;
a jelly roll disposed in the can and comprising a positive electrode and a negative electrode, wherein positive winding foils protrude from a positive end of the jelly roll and negative winding foils protrude from a negative end of the jelly roll, and wherein the positive winding foils are folded in a same direction to overlap each other in a first pattern of recesses and the negative winding foils are folded in a same direction to overlap each other in a second pattern of recesses;
a positive disk comprising a plurality of leg forms corresponding to the first pattern of recesses formed in the positive winding foils, wherein the plurality of leg forms is welded into the first pattern of recesses;
a negative disk comprising a plurality of leg forms corresponding to the second pattern of recesses formed in the negative winding foils, wherein the plurality of leg forms is welded into the second pattern of recesses;
wherein at least one of the positive disk and the negative disk is electrically insulated from the can.

2. The electrochemical cell of claim 1, further comprising:
a positive terminal attached to the positive disk and electrically insulated from the can;
and a negative terminal attached to the negative disk.

3. The electrochemical cell of claim 2, wherein the negative terminal is electrically insulated from the can.

4. The electrochemical cell of claim 2, wherein both the positive terminal and the negative terminal are electrically insulated from the can.

5. The electrochemical cell of claim 4, wherein the can is a cylinder.

6. The electrochemical cell of claim 1, wherein the positive winding foils and the negative winding foils are folded in a radially outward direction.

7. The electrochemical cell of claim 1, wherein the can is a cylinder.

8. A method of manufacturing an electrochemical cell comprising a tabless jelly roll, the method comprising:
applying a radial force across positive winding foils on a positive end of the tabless jelly roll such that the positive winding foils are folded in a radial direction to overlap each other in a first pattern of recesses;
applying a radial force across negative winding foils on a negative end of the tabless jelly roll such that the negative winding foils are folded in a radial direction to overlap each other in a second pattern of recesses;
providing a positive disk and a negative disk, wherein the positive disk comprises a plurality of leg forms corresponding to the first pattern of recesses formed in the positive winding foils and the negative disk comprises a plurality of leg forms corresponding to the second pattern of recesses formed in the positive winding foils;
welding the plurality of leg forms of the positive disk to the first pattern of recesses formed in the positive winding foils;
welding the plurality of leg forms of the negative disk to the second pattern of recesses formed in the negative winding foils;
disposing the tabless jelly roll into a can;
electrically insulating at least one of the positive disk and the negative disk from the can.

9. The method of claim 8, wherein the applied radial force is in an outward direction relative to an axis of the tabless jelly roll.

10. The method of claim 8, further comprising:
welding a terminal stud to each of the positive disk and the negative disk.

11. The method of claim 8, wherein both the positive disk and the negative disk are electrically insulated from the can.

12. The method of claim 8, wherein the applying of radial force is performed using forming leaves pivotally attached to a forming tool body.

13. The method of claim 12, wherein the forming tool body is cylindrical and has at least four forming leaves spaced at about equal angles apart.

14. A forming tool for forming a pattern of recesses in a jelly roll, the forming tool comprising:
a body;
a spindle configured to move along an axis within the body;
a plurality of forming leaves pivotally attached to the spindle and configured to push the spindle axially inward in response to a pressing force and change in angle relative to the axis.

15. The forming tool of claim 14, wherein the spindle is spring loaded to rest in an extended position with the plurality of forming leaves at an upward angle.

16. The forming tool of claim 14, wherein each of the plurality of leaves is pinned within a slot to the body.
